(19) United States
(12) Patent Application Publication
(10) Pub. No.: US 2008/0109139 A1
(43) Pub. Date: May 8, 2008

(54) Vehicle, vehicle control device, and vehicle control method

(75) Inventors: Koichiro Muta, Okazaki-shi (JP); Tomokazu Nomura, Anjo-shi (JP); Daisuke Suyama, Toyota-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); AISIN AW CO., LTD., ANJO-SHI (JP)

(21) Appl. No.: 11/902,618

(22) Filed: Sep. 24, 2007

(30) Foreign Application Priority Data
Nov. 8, 2006 (JP) 2006-303061

(51) Int. Cl. G06F 17/00

(52) U.S. Cl. 701/48; 477/4; 477/5; 477/77

(57) ABSTRACT

A vehicle includes a drive device applying a driving force to a wheel, a brake device applying a braking force to the vehicle, and a control device controlling the drive device and the brake device. When the traveling direction and the acting direction of the driving force are opposite, the control device causes the drive device to generate a driving force corresponding to a driving force demand in the event of the drive device not entering an operation disallowed region even if the driving force corresponding to the driving force command is generated at the drive device, and causes the brake device to operate according to the drive driving force demand in the event of the drive device entering the operation disallowed region if the driving force corresponding to said driving force demand is generated at said drive device.

This nonprovisional application is based on Japanese Patent Application No. 2006-303061 filed with the Japan Patent Office on Nov. 8, 2006, the entire contents of which are hereby incorporated by reference.

### BACKGROUND OF THE INVENTION

1. Field of the Invention

The present invention relates to a vehicle, a control device for a vehicle, and a control method for a vehicle.

2. Description of the Background Art

There is known a drive device for a hybrid vehicle, including a power split mechanism dividing the engine output to a first electric motor and an output shaft, and a second electric motor provided between the output shaft of the power split mechanism and the driving wheel.

In such a drive device for a hybrid vehicle, the power split mechanism is formed of, for example, a planetary gear set. By the differential action of the planetary gear set, the motive power from the engine is mainly transmitted mechanically to the driving wheel, and the remainder of the motive power from the engine is transmitted to the driving wheel through an electric path from the first electric motor to the second electric motor. By such control, the function as a continuously variable transmission is realized. The vehicle can run with the engine maintained at the optimum operating state to improve the fuel consumption.

Japanese Patent Laying-Open No. 2006-29439 discloses a drive device for a vehicle, based on a configuration having an automatic transmission further combined with the drive device of a hybrid vehicle set forth above.

In the vehicle drive device disclosed in this publication, there are cases where the clutch of the automatic transmission (AT) should be disengaged in order to prevent over-revving of the first electric motor when the vehicle is moving in a direction opposite to the direction corresponding to the shift range. However, there is a problem that the driving force intended by the driver, even though requested, cannot be output to the axle since the driving unit including the engine and electric motor is disconnected from the axle by means of the clutch.

Specifically, in the case where the vehicle moves backward at an upward climbing road when the shift lever is at the D (drive) position, it may be better to disengage the clutch of the automatic transmission to achieve a neutral range from the standpoint of protecting the electric motor. However, it is undesirable to suppress generation of a forward thrust, in the event of the driver of the vehicle intentionally stepping on the accelerator pedal in the state where the shift lever is at the D position.

### SUMMARY OF THE INVENTION

An object of the present invention is to provide a vehicle having the competing considerations of protecting the drive device and responding to the drive demand both established, a control device for such a vehicle, and a control method for such a vehicle.

The invention is directed to a vehicle including a drive device applying a driving force to a wheel, a brake device applying a braking force to the vehicle, and a control device controlling the drive device and brake device. When a traveling direction of the vehicle and an acting direction of the driving force are opposite, the control device causes the drive device to generate a driving force corresponding to a driving force demand in an event of the drive device not entering an operation disallowed region even if the driving force corresponding to the driving force demand is generated at the drive device. Also, the control device causes the brake device to operate corresponding to the driving force demand in the event of the drive device entering the operation disallowed region if the driving force corresponding to the driving force demand is generated at the drive device.

Preferably, the drive device includes at least one of an internal combustion engine and an electric motor. The brake device includes a brake exerting a frictional force on an element attached to the rotational shaft of the wheel.

More preferably, the vehicle further includes a transmission device arranged between the drive device and a drive shaft to drive the wheel. The transmission device includes a clutch mechanism to switch between transmission and non-transmission of a driving force. When the traveling direction and the acting direction of the driving force are opposite, the control device controls the clutch mechanism to attain a driving force non-transmission state in the event of the drive device entering an operation disallowed region if the driving force corresponding to the driving force demand is generated at the drive device.

Preferably, the drive device includes an internal combustion engine, first and second electric motors, and a power split mechanism having three input shafts connected to respective output shafts of the first electric motor, the second electric motor, and the internal combustion engine. The brake device includes a brake exerting a frictional force on an element attached to the rotational shaft of the wheel.

More preferably, the vehicle further includes a transmission device arranged between the output shaft of the second electric motor and the drive shaft to drive the wheel. The transmission device includes a clutch mechanism to switch between transmission and non-transmission of a driving force. When the traveling direction and the acting direction of the driving force are opposite, the control device controls the clutch mechanism to attain a driving force non-transmission state in the event of the drive device entering an operation disallowed region if a driving force corresponding to the driving force demand is generated at the drive device.

Preferably, the vehicle further includes a sensor detecting the step-on amount of the accelerator pedal. The driving force demand is increased according to the step-on amount of the accelerator pedal.

According to another aspect of the present invention, a control device for a vehicle includes a drive device applying a driving force to a wheel, and a brake device applying a braking force to the vehicle. The control device includes a sensor sensing a traveling direction of the vehicle, and a control unit causing, when the traveling direction and the acting direction of the driving force are opposite, the drive device to generate a driving force corresponding to a driving force demand in the event of the drive device not entering an operation disallowed regions even if the driving force corresponding to the driving force demand is generated at the drive device, and the brake device to operate according to the driving force demand in the event of the drive device entering an operation disallowed region if the driving force corresponding to the driving force demand is generated at the drive device.

Preferably, the drive device includes at least one of an internal combustion engine and an electric motor. The brake device includes a brake exerting a frictional force on an element attached to a rotational shaft of the wheel.

More preferably, the vehicle further includes a transmission device arranged between the drive device and a drive shaft to drive the wheel. The transmission device includes a clutch mechanism to switch between transmission and non-transmission of a driving force. When the traveling direction and the acting direction of the driving force are opposite, the control device controls the clutch mechanism to attain a driving force non-transmission state in the event of the drive device entering the operation disallowed region if the driving force corresponding to the driving force demand is generated at the drive device.

Preferably, the drive device includes an internal combustion engine, first and second electric motors, and a power split mechanism having three input shafts connected to respective output shafts of the first electric motor, the second electric motor, and the internal combustion engine. The brake device includes a brake exerting a frictional force on an element attached to the rotational shaft of the vehicle.

More preferably, the vehicle further includes a transmission device arranged between the output shaft of the second electric motor and the drive shaft to drive the wheel. The transmission device includes a clutch mechanism to switch between transmission and non-transmission of a driving force. When the traveling direction and the acting direction of the driving force are opposite, the control device controls the clutch mechanism to attain a driving force non-transmission state in the event of the drive device entering an operation disallowed region if the driving force corresponding to the driving force demand is generated at the drive device.

Preferably, the vehicle further includes a sensor detecting a step-on amount of an accelerator pedal. The driving force demand is increased according to the step-on amount of the accelerator pedal.

According to a further aspect of the present invention, a control method for a vehicle including a drive device applying a driving force to a wheel, and a brake device applying a braking force to the vehicle, includes the steps of: determining whether a condition of a traveling direction and an acting direction of the driving force being opposite, and the drive device entering an operation disallowed region if the driving force corresponding to the driving force demand is generated at the drive device is satisfied or not; causing the drive device to generate a driving force corresponding to the driving force demand when the condition is not satisfied, and causing the brake device to operate according to the driving force demand when the condition is satisfied.

Preferably, the drive device includes at least one of an internal combustion engine and an electric motor. The brake device includes a brake exerting a frictional force on an element attached to the rotational shaft of the wheel.

More preferably, the vehicle further includes a transmission device arranged between the drive device and a drive shaft to drive the wheel. The transmission device includes a clutch mechanism to switch between transmission and non-transmission of the driving force. The control method for a vehicle further includes the step of controlling the clutch mechanism to attain a driving force non-transmission state when the condition is satisfied.

Preferably, the drive device includes an internal combustion engine, first and second electric motors, and a power split mechanism having three input shafts connected to respective output shafts of the first electric motor, the second electric motor, and the internal combustion engine. The brake device includes a brake exerting a frictional force on an element attached to the rotational shaft of the wheel.

More preferably, the vehicle further includes a transmission device arranged between the output shaft of the second electric motor and a drive shaft to drive the wheel. The transmission device includes a clutch mechanism to switch between transmission and non-transmission of a driving force. The control method further includes the step of controlling the clutch mechanism to attain a driving force non-transmission state when the condition is satisfied.

Preferably, the vehicle further includes a sensor detecting a step-on amount of an accelerator pedal. The driving force demand is increased according to the step-on amount of the accelerator pedal.

According to the present invention, a vehicle behavior corresponding to a drive demand is realized while protecting the drive device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a main configuration of a vehicle 1 of the present embodiment.

FIG. 2 represents the details of a drive transmission mechanism 10 including a drive device 11 and a transmission device 20 of FIG. 1.

FIG. 3 is an engagement operation table of drive transmission mechanism 10.

FIG. 4 is a diagram to describe the operation of the shift lever.

FIG. 5 is a flowchart of a process allowing a response to a demand of the driving force while protecting the unit of the drive device.

FIG. 6 represents an example of a map to determine the drive torque.

FIG. 7 is a nomographic chart to describe over-revving of a first electric motor MG1.

FIG. 8 is a diagram to describe the restricted range of an engine speed Ng and revolution speed Nm of the second electric motor.

FIG. 9 represents the relationship between brake oil pressure and braking force.

FIG. 10 is a diagram to describe an example of a vehicle behavior according to an embodiment.

### DESCRIPTION OF THE PREFERRED EMBODIMENTS

An embodiment of the present invention will be described in detail hereinafter with reference to the drawings. In the drawings, the same or corresponding element have the same reference characters allotted, and description thereof will not be repeated.

Overall Configuration

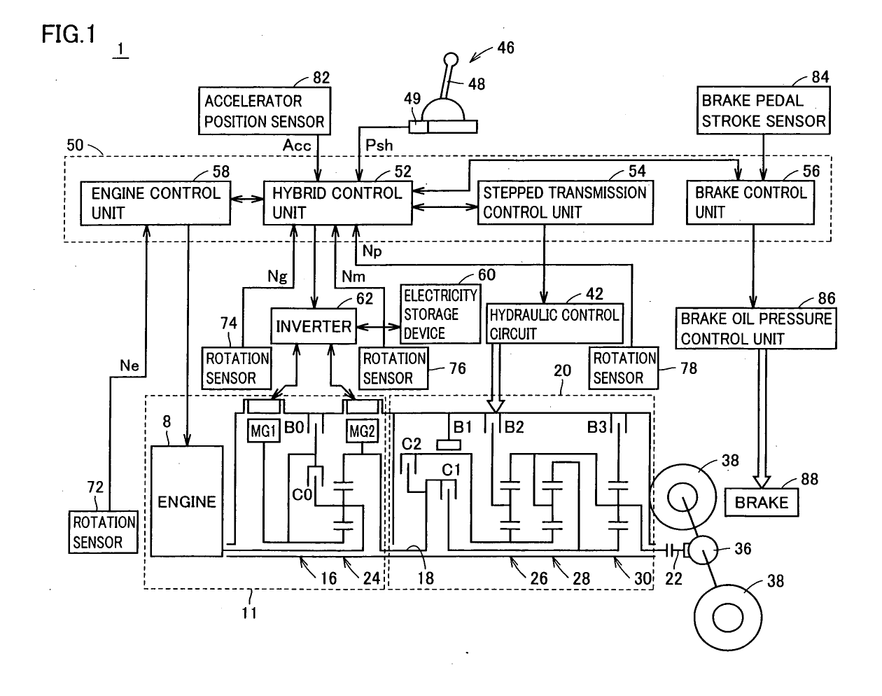

FIG. 1 represents the main configuration of a vehicle 1 of the present embodiment.

Referring to FIG. 1, vehicle 1 includes a drive device 11 applying a driving force to a wheel 38, a brake device (88) applying a braking force to wheel 38, and a control device 50 controlling drive device 11 and the brake device (88). When the traveling direction and the acting direction of the driving force are opposite, control device 50 causes drive device 11 to generate a driving force corresponding to a driving force demand (Acc) in the event of drive device 11 not entering an operation disallowed regions even if the driving force corresponding to the driving force demand (Acc) is generated at drive device 11. Also, control device 50 causes brake device 88 to operate according to the driving force demand (Acc) in the event of drive device 11 entering an operation disallowed region if a driving force corresponding to the driving force demand (Acc) is generated at drive device 11.

Preferably, drive device 11 includes an engine 8, first and second electric motors MG1 and MG2, and a power split mechanism 16 having three input shafts connected to respective output shafts of electric motor MG1, electric motor MG2, and engine 8. The brake device (88) includes a brake 88 exerting a frictional force on an element attached to the rotational shaft of wheel 38.

More preferably, vehicle 1 further includes a transmission device 20 arranged between the output shaft of electric motor MG2 and a drive shaft 22 to drive wheel 38. Transmission device 20 includes clutches C1 and C2 to switch between transmission and non-transmission of a driving force. When the traveling direction and the acting direction of the driving force are opposite, control device 50 controls clutches C1 and C2 to attain a driving force non-transmission state in the event of drive device 11 entering an operation disallowed region if the driving force corresponding to the driving force demand (Acc) is generated at drive device 11.

Preferably, vehicle 1 further includes an accelerator position sensor 82 detecting a step-on amount of the accelerator pedal. The driving force demand (Acc) is increased according to the step-on amount of the accelerator pedal.

Vehicle 1 further includes an a manipulation device 46 switching between a plurality of shift positions by manual operation, a brake pedal stroke sensor 84, rotation sensors 72, 74, 76, and 78, an inverter 62, an electricity storage device 60, a hydraulic control circuit 42, a brake oil pressure control unit 86, and a differential gear device 36.

Control device 50 includes an engine control unit 58, a hybrid control unit 52, a stepped transmission control unit 54, and a brake control unit 56.

Basic Operation

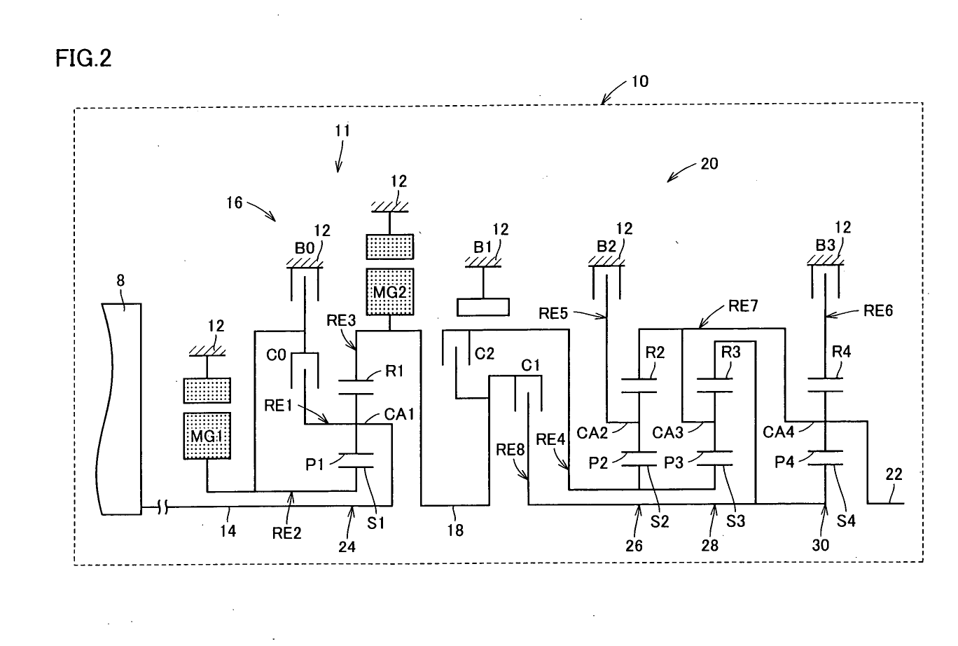

Referring to FIG. 2, drive device 11 includes engine 8, power split mechanism 16, and motor generators MG1 and MG2.

An input shaft 14 is an input rotary member disposed on a common shaft center in a transmission case 12 (hereinafter, case 12), qualified as a non-rotary member, attached to the vehicle. Power split mechanism 16 is a power delivery device coupled to input shaft 14.

Transmission device 20 is a stepped type automatic transmission (AT) connected in series via a transmission member (drive transmission shaft) 18 at the power transmission path between power split mechanism 16 and wheel 38. Drive shaft 22 is an output rotary member coupled to this transmission device 20.

Drive transmission mechanism 10 is particularly suitable for usage in an FR (front engine rear drive) vehicle which corresponds to a longitudinal layout. Engine 8 is driving force source to move the vehicle, coupled directly to or indirectly via a pulsation absorption damper not shown to input shaft 14, identified as an internal combustion engine such as a gasoline engine or diesel engine.

As shown in FIG. 1, the power from engine 8 is transmitted to a pair of wheels 38 sequentially through a differential gear device (final drive) 36, a pair of axles, and the like, constituting the power transmission path partially as a portion in addition to the portion of the drive device.

Elements in drive transmission mechanism 10 other than engine 8 are configured symmetrical about the shaft center. Therefore, the lower side is not illustrated in the region representing drive transmission mechanism 10 of FIGS. 1 and 2.

Drive device 11 includes engine 8, first electric motor MG1, power split mechanism 16, and second electric motor MG2. Power split mechanism 16 is a mechanical mechanism to mechanically distribute the output of engine 8 applied to input shaft 14, and operates as a differential mechanism distributing the output of engine 8 to first electric motor MG1 and transmission member 18. Second electric motor MG2 includes a rotor provided to rotate integrally with transmission member 18.

First and second electric motors MG1 and MG2 are the so-called motor generators, additionally including a power generation function. First electric motor MG1 includes at least a generator (power generation) function to generate reactive force. Second electric motor 2 includes at least a motor (electric motor) function to output a driving force, qualified as the driving force source to move the vehicle.

Power split mechanism 16 includes a single-pinion type first planetary gear device 24 having a predetermined gear ratio ρ1 of approximately 0.418, for example, a switching clutch C0 and a switching brake B0. First planetary gear device 24 includes, as rotary elements, a first sungear S1, a first planetary gear P1, a first carrier CA1 supporting first planetary gear P1 to allow a rotary motion on its axis as well as an orbital motion, and a first ring gear R1 meshing with first sungear S1 via first planetary gear P1. Gear ratio ρ1 is ZS1/ZR1, where ZS1 is the number of teeth of first sungear S1 and ZR1 is the number of teeth of first ring gear R1.

In power split mechanism 16, first carrier CA1 is linked to input shaft 14, i.e. engine 8. First sungear S1 is linked to first electric motor MG1. First ring gear R1 is linked to transmission member 18.

Switching brake B0 is located between first sungear S1 and case 12. Switching clutch C0 is located between first sungear S1 and first carrier CA1. When switching clutch C0 and switching brake B0 are released, first sungear S1, first carrier CA1, and first ring gear R1 that are the three elements of first planetary gear device 24 attain a relatively rotatable state with each other in power split mechanism 16.

In this state, the output of engine 8 is distributed to first electric motor MG1 and transmission member 18. In addition, electricity storage device 60 is charged with the electrical energy generated from first electric motor MG1 based on the distributed portion of the output of engine 8. Also, second electric motor MG2 is driven rotatably. In drive device 11, power split mechanism 16 can function as an electrical differential device to attain a continuously variable transmission state (electrically CVT state), allowing continuous change of the rotation of transmission member 18 independent of the predetermined rotation of engine 8.

In other words, when power split mechanism 16 attains a differential state, drive device 11 also attains a differential state, functioning as a drive device with an electrical continuously variable transmission having a gear ratio γ0 (revolution speed of input shaft 14/revolution speed of transmission member 18) varied continuously from the lowest value γ0min to the highest value γ0max.

When switching clutch C0 or switching brake B0 is engaged, power split mechanism 16 attains a nondifferential state where a differential action is disallowed.

When switching clutch C0 is engaged so that first sungear S1 and first carrier CA1 are engaged integrally, power split mechanism 16 attains a locked state where first sungear S1, first carrier CA1 and first ring gear R1 that are the three elements of first planetary gear device 24 rotate together, i.e. rotate integrally.

Since a state is achieved in which the rotation of engine 8 matches the revolution speed of transmission member 18, power split mechanism 16 takes a constant transmission state having the gear ratio γ0 fixed to “1”.

When switching brake B0 is then engaged instead of switching clutch C0 so that first sungear S1 is linked with case 12, power split mechanism 16 attains a locked state having first sungear S1 fixed in a nonrotation state.

Since first ring gear R1 is rotated faster than first carrier CA1, power split mechanism 16 functions as an overdrive mechanism. Power split mechanism 16 takes a constant transmission state having the gear ratio γ0 fixed to a value lower than “1”, for example, approximately 0.7.

Thus, switching clutch C0 and switching brake B0 can set power split mechanism 16 in a differential state and non-differential state. In other words, switching clutch C0 and switching brake B0 function as a switching device selectively switching power split mechanism 16 between a continuously variable transmission state (differential state) operating as a continuously variable transmission that can have the gear ratio varied continuously and a constant gear state (non-differential state) with the gear ratio locked constant.

Transmission device 20 includes a second planetary gear device 26 of the single pinion type, a third planetary gear device 28 of the single pinion type, and a fourth planetary gear device 30 of the single pinion type.

Second planetary gear device 26 includes a second sungear S2, a second planetary gear P2, a second carrier CA2 supporting second planetary gear P2 to allow a rotary motion on its axis as well as an orbital motion, and a second rear gear R2 meshing with second sun gear S2 via second planetary gear P2. Second planetary gear device 26 has a predetermined gear ratio ρ2 of approximately 0.562, for example. Gear ratio ρ2 is ZS2/ZR2, where ZS2 is the number of teeth of second sungear S2, and ZR2 is the number of teeth of second ring gear R2.

Third planetary gear device 28 includes a third sungear S3, a third planetary gear P3, a third carrier CA3 supporting third planetary gear P3 to allow a rotary motion on its axis as well as an orbital motion, and a third rear gear R3 meshing with third sun gear S3 via third planetary gear P3. Third planetary gear device 28 has a predetermined gear ratio ρ3 of approximately 0.425, for example. Gear ratio ρ3 is ZS3/ZR3, where ZS3 is the number of teeth of third sungear S3, and ZR3 is the number of teeth of third ring gear R3.

Fourth planetary gear device 30 includes a fourth sungear S4, a fourth planetary gear P4, a fourth carrier CA4 supporting fourth planetary gear P4 to allow a rotary motion on its axis as well as an orbital motion, and a fourth ring gear R4 meshing with fourth sun gear S4 via fourth planetary gear P4. Fourth planetary gear device 30 has a predetermined gear ratio ρ4 of approximately 0.421, for example. Gear ratio ρ4 is ZS4/ZR4, where ZS4 is the number of teeth of fourth sungear S4, and ZR4 is the number of teeth of fourth ring gear R4.

Second sungear S2 and third sungear S3 are linked integrally, and selectively linked to transmission member 18 via second clutch C2. Second sungear S2 and third sungear S3 are selectively linked to case 12 via a first brake B1.

Second carrier CA2 is selectively linked to case 12 via a second brake B2. Fourth ring gear R4 is selectively linked to case 12 via a third brake B3.

Second ring gear R2, third carrier C3, and fourth carrier CA4 are linked integrally to drive shaft 22. Third ring gear R3 and fourth sun gear S4 are linked integrally, and selectively linked to transmission member 18 via first clutch C1.

Thus, transmission device 20 and transmission member 18 are selectively linked via first clutch C1 or second clutch C2 employed to establish a speed gear in transmission device 20. In other words, first and second clutches C1 and C2 function as an engagement device to selectively switch the power transmission path between transmission member 18 and wheel 38 to a power transmission allowed state allowing power transmission and a power transmission cutoff state cutting off power transmission.

In other words, the power transmission path is set at the power transmission allowed state when at least one of first clutch C1 and second clutch C2 is engaged, and set at the power transmission cutoff state when first clutch C1 and second clutch C2 are released.

Switching clutch C0, first clutch C1, second clutch C2, switching brake B0, first brake B1, second brake B2, and third brake B3 are the hydraulic friction engagement device often employed in a general vehicle automatic transmission. The hydraulic friction engagement device is configured as a wet multi-plate type in which a plurality of stacked friction plates are depressed by a hydraulic actuator, or as a band brake having one end of one or two bands wrapped around the periphery of a rotating drum pulled tight by a hydraulic actuator to selectively link the members located at either side of the band brake.

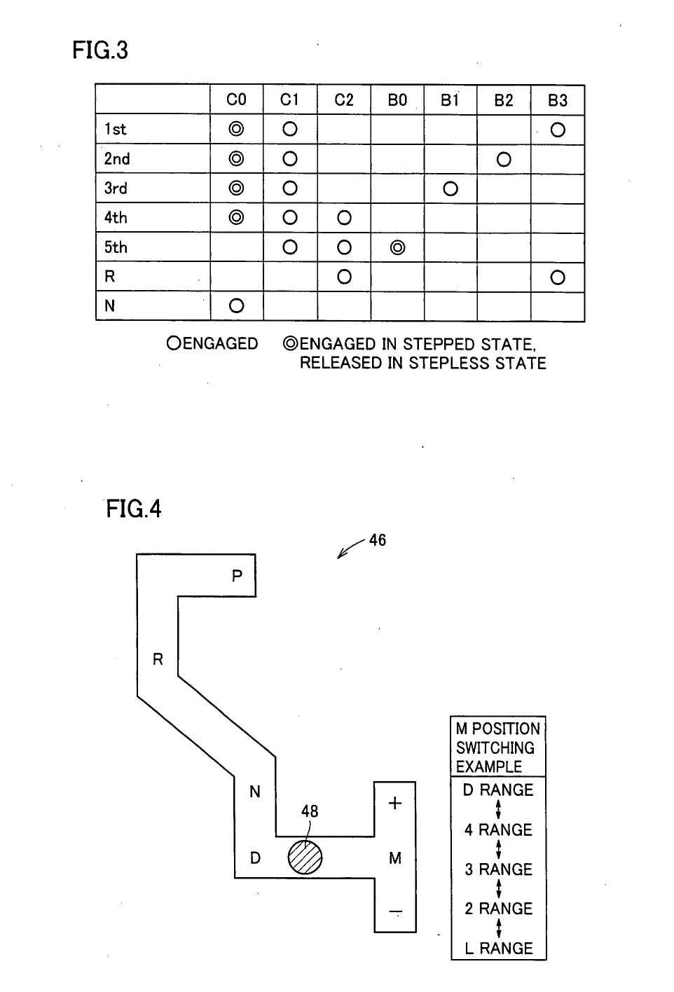

FIG. 3 is an engagement operation table of drive transmission mechanism 10.

As shown in FIG. 3, any of first speed gear (first gear) to fifth speed gear (fifth gear), or a reverse gear (gear for driving backwards) or neutral is selectively established by the selective engaging operation of switching clutch C0, first clutch C1, second clutch C2, switching brake B0, first brake B1, second bake B2 and third brake B3.

It is to be particularly noted that power split mechanism 16 includes switching clutch C0 and switching brake B0 in the present embodiment. By the engaging operation of any of switching clutch C0 and switching brake B0, power split mechanism 16 can establish, in addition to a continuously variable transmission state operating as a continuously variable transmission, a constant gear state operating as a transmission having a constant gear ratio.

For example, when drive transmission mechanism 10 functions as a stepped transmission, the first speed gear having a gear ratio γ¹ of the highest value, for example, approximately 3.357, is established by the engagement of switching clutch C0, first clutch C1 and third brake B3, as shown in FIG. 3.

The second speed gear having a gear ratio γ2 smaller than that of the first gear, for example, approximately 2.180, is established by the engagement of switching clutch C0, first clutch C1 and second brake B2.

The third speed gear having a gear ratio γ3 smaller than that of the second gear, for example, approximately 1.424, is established by the engagement of switching clutch C0, first clutch C1 and first brake B1.

The fourth speed gear having a gear ratio γ4 smaller than that of the third gear, for example, approximately 1.000, is established by the engagement of switching clutch C0, first clutch C1 and second clutch C2.

The fifth speed gear having a gear ratio γ5 smaller than that of the fourth gear, for example, approximately 0.705, is established by the engagement of first clutch C1, second clutch C2, and switching brake B0.

The reverse gear “R” having gear ratio γR taking a value between the first gear and second gear, for example approximately 3.209, is established by the engagement of second clutch C2 and third brake B3.

When in neutral “N”, switching clutches C1 and C2 are released, and only clutch C0 is engaged. As will be described afterwards, clutch C0 takes a released state when neutral position is achieved for the purpose of protecting the drive device even though the shift lever position is not at “N”.

When drive transmission mechanism 10 functions as a continuously variable transmission, switching clutch C0 and switching brake B0 are both released, as shown in the engagement table of FIG. 3. Accordingly, power split mechanism 16 and electric motors MG1 and MG2 function as a continuously variable transmission, and transmission device 20 in series thereto functions as a stepped transmission. The revolution speed applied to transmission device 20, i.e., the revolution speed of transmission member 18, is varied in a stepless manner with respect to each of the first speed, second speed, third speed, and fourth speed of transmission device 20. A stepless gear ratio width is obtained for each gear. Therefore, the gear ratio between each gear corresponds to a stepless continuous value. Thus, the total gear ratio (overall gear ratio) γT for the entirety of drive transmission mechanism 10 is obtained in a stepless manner.

Manipulation device 46 of FIG. 1 is disposed at the side of the driver seat, for example, and includes a shift lever 48 manipulated for the selection of a plurality of shift positions.

FIG. 4 is a diagram to describe the manipulation of the shift lever.

Referring to FIG. 4, shift lever 48 is configured to be operated manually to a park position “P (parking)”, reverse position “R (reverse)”, neutral position “N (neutral)”, forward automatic transmission shift position “D (drive)”, or forward manual shift position “M (manual)”.

In park position “P (parking)”, control is effected such that neither clutch C1 nor clutch C2, qualified as an engagement device, is engaged, as shown in the engagement operation table of FIG. 3. A neutral state is established in which the power transmission path in transmission device 20 is disconnected, and drive shaft 22 of transmission device 20 is locked. In neutral position “N (neutral)”, a neutral state is established in which the power transmission path in drive transmission mechanism 10 is disconnected.

For example, in response to the manual operation to each shift position of shift lever 48, the manual valve mechanically linked to shift lever 48 is switched. Hydraulic control circuit 42 is mechanically switched such that reverse gear “R”, neutral “N”, forward gear “D”, or the like is established, as shown in the engagement operation table of FIG. 3. Each of the first to fifth speed gear indicated in the engagement operation table of FIG. 3 at “D” or “M” position is established by the electrical switching of the electromagnetic valve in hydraulic control circuit 42.

Thus, manipulation device 46 functions as a forward-reverse switch manipulation device, directed to the shift state of drive transmission mechanism 10, switching between the forward shift state “D” or “M” to move forwardly, and the reverse shift state “R” to move backwardly by manual operation.

The non-drive position of P and N is a non-moving position having the power transmission path disconnected.

Each drive position of “R”, “D”, and “M” is a driving position to select switching to a power transmission allowed state of the power transmission path.

The “D” position is the highest speed drive position. The “4” to “L” range at the “M” position corresponds to the engine brake range in which the engine brake effect is achieved.

The “M” position is located corresponding to the “D” position in the vehicle longitudinal direction, adjacent thereto sideways. Manipulation of shift lever 48 to the M position allows any of the “D” range to “L” range to be selected in response to the operation of shift lever 48. Specifically, the “M” position includes an upshift position “+” and a downshift position “−” in the longitudinal direction of the vehicle. When shift lever 48 is manipulated to the upshift position “+” or downshift position “−”, one of the “D” range to “L” range is selected.

For example, the five gear ranges of “D” range to “L” range selected at the “M” position are qualified as a plurality of types of transmission ranges having a different total gear ratio γT at the high speed side (gear ratio at the lowest side) in the varying range of total gear ratio γT corresponding to the controllable automatic transmission of drive transmission mechanism 10, and restricts the transmission range of the transmission (speed gear) such that the highest speed gear allowed in transmission device 20 differs for each range.

Shift lever 48 is configured to automatically return to the “M” position from the aforementioned upshift position “+” and downshift position “−” by a biasing means such as a spring. Manipulation device 46 includes a shift position sensor 49 to detect each shift position of shift lever 48. A signal Psh representing the shift position of shift lever 48, the number of manipulations at the “M” position, and the like are provided to control device 50.

Protection Operation of Drive Device Unit

From the standpoint of protecting the components, the upper limit of the revolution speed of each rotary element is determined in drive device 11. Particularly in the case where clutch C0 and brake B0 of power split mechanism 16 are released and a continuously variable transmission operation is executed, over-revving of first electric motor MG1 must be prevented. For example, in the case where the vehicle moves in a direction opposite to the direction indicated by the shift range such as in the case where the vehicle will move backwards at a climbing road when the shift lever is set at the “D” or “M” position in a shift range of the forward direction, or in the case where the shift lever is set to the “D” position immediately after the vehicle is moved backwards with the shift lever set at the “R” position, over-revving readily occurs. On this occasion, transmission device 20 must be set to neutral in order to protect first electric motor MG1. However, it is not preferable if the vehicle does not respond when the driver steps on the accelerator pedal intentionally demanding a driving force.

FIG. 5 is a flowchart of the process that allows responding to the demand for a driving force while gaining protection of the drive device portion.

Referring to FIGS. 1 and 5, upon initiation of the process, control device 50 determines the drive torque based on the vehicle speed and accelerator position at step S1.

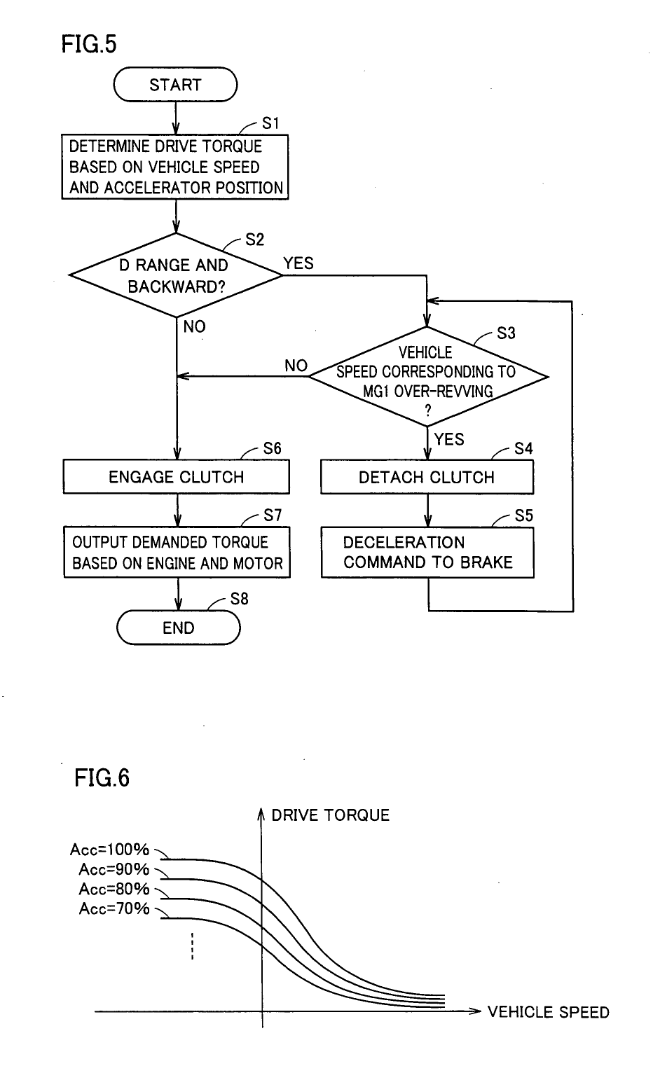

FIG. 6 represents an example of the map to determine the drive torque.

In control device 50 of FIG. 1, hybrid control unit 52 refers to the map of FIG. 5 to determine the drive torque. Hybrid control unit 52 receives an accelerator pedal position Acc from accelerator position sensor 82. Hybrid control unit 52 calculates the vehicle speed based on revolution speed Nm of second electric motor MG2 from rotation sensor 76 or revolution speed Np of the drive shaft from rotation sensor 78. The map of FIG. 5 defines the drive torque corresponding to the vehicle speed when the accelerator position Acc corresponds to 100%, 90%, 80%, 70%, . . . .

Upon such calculation of drive torque at step S1, control proceeds to step S2 where determination is made as to whether the vehicle is at the D range and backward. As used herein, the D range implies that drive device 11 and transmission device 20 are set such that the driving force of the drive source is transmitted to the wheel as the torque to move the vehicle forwardly. For example, hybrid control unit 52 can identify that the vehicle is at the D range by virtue of shift position sensor 49 sensing the setting of the shift lever at the “D” or “M” position.

“Backward” in step S2 indicates that the vehicle is moving backwards, independent of the position of the shift lever. For example, hybrid control unit 52 can identify that the vehicle is moving backward in response to rotation sensor 78 detecting rotation of drive shaft 22 that rotates in cooperation mechanically with the rotation of wheel 38. In the state where clutch C1 or C2 is connected, detection of the vehicle moving backward can be made by the rotation of transmission member 18 through rotation sensor 76.

At step S2, detection is based on the setting of the shift lever indicating forward drive, and the vehicle moving backward. Alternatively, detection of the shift lever being set to reverse and the vehicle moving forward can be made.

When the condition of step S2 is established (YES at S2), control proceeds to step S3, otherwise (NO at S2), control proceeds to step S6.

At step S3, determination is made as to whether the vehicle speed corresponds to over-revving of first electric motor MG1.

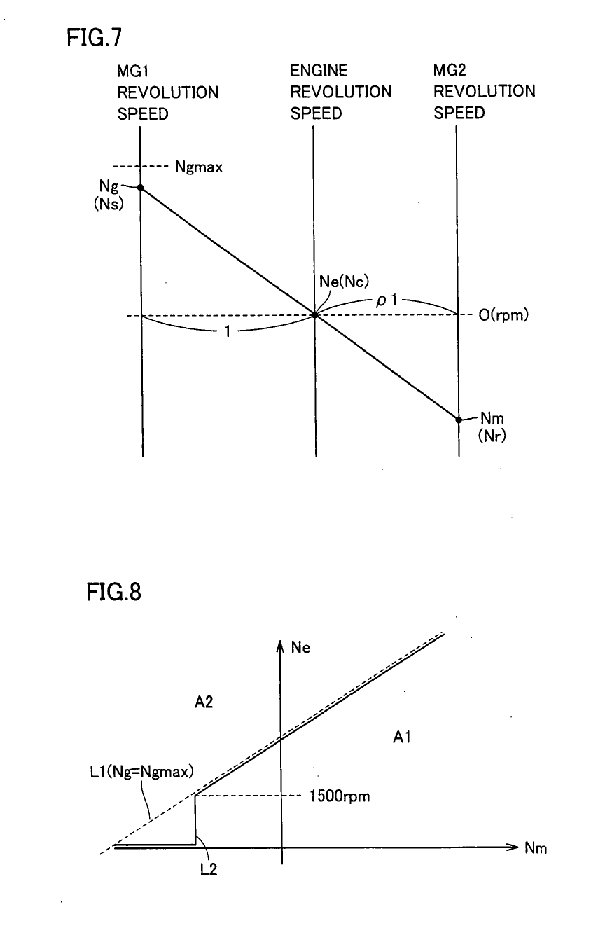

FIG. 7 is a nomographic chart to describe over-revving of first electric motor MG1.

Referring to FIGS. 2 and 7, power split mechanism 16 is a planetary gear mechanism. Revolution speed Ns of sungear S1, revolution speed Nc of carrier CA1, and revolution speed Nr of ring gear R1 establish the relationship of being located on a straight line corresponding to the following equation (1).

Nr=−ρ1*Ns+(1+ρ1)*Nc (1)

According to the configuration of FIG. 2, revolution speed Ns of sungear S1 is equal to revolution speed Ng of first electric motor MG1. Revolution speed Nc of carrier CA1 is equal to engine speed Ne. Revolution speed Nr of ring gear R1 is equal to revolution speed Nm of second electric motor MG2. In power split mechanism 16, the following equation (2) is established.

Nm=−ρ1*Ng+(1+ρ1)*Ne (2)

When the upper limit revolution speed of first electric motor MG1 in FIG. 7 is Ngmax, engine speed Ng and revolution speed Nm of second electric motor MG2 is restricted to the range of Ng<Ngmax.

FIG. 8 is a diagram to describe the restricted range of engine speed Ng and revolution speed Nm of second electric motor MG2.

The straight line L1 in FIG. 8 represents the following equation (3) obtained by inserting Ng=Ngmax into equation (2) set forth above.

Ne=1/(1+ρ1)*Nm+ρ1/(1+ρ1)*Ngmax (3)

Region A2 above straight line L1 is an operation disallowed region that is determined depending upon the limitation of first electric motor MG1. Region A1 below straight line L1 is the operation allowed region that is determined depending upon the limitation of first electric motor MG1.

Since self-sustained driving is disallowed if the engine speed is lower than that of an idle condition (for example, 1500 rpm), the engine speed is controlled to zero in practice, as shown in line L2, for engine 8 when revolution speed Nm of second electric motor MG2 takes a high absolute value at the negative region. Accordingly, the operating point sometimes will be shifted from operation disallowed region A2 to operation allowed region A1.

Determination as to whether the vehicle speed corresponds to over-revving of first electric motor MG1 or not at step S3 of FIG. 5 will be described hereinafter. Hybrid control unit 52 retains the vehicle speed V as the control parameter based on drive shaft revolution speed Np detected at rotation sensor 78 or revolution speed Nm detected at rotation sensor 76. Vehicle speed V is converted into revolution speed Nm by calculation. By identifying whether the combination of the current engine speed Ne and revolution speed Nm belongs to region A2 of FIG. 8 or not, determination can be made as to whether the vehicle speed corresponds to over-revving of first electric motor MG1 at step S3. Engine speed Ne is detected by rotation sensor 72 of FIG. 1 and applied to hybrid control unit 52 via engine control unit 58.

When determination is made that the vehicle speed will cause over-revving of first electric motor MG1 at step S3 of FIG. 5, control proceeds to step S4, otherwise (NO at step S4), control proceeds to S6.

At step S4, clutches C1 and C2 are both released in transmission device 20, whereby drive device 11 is detached from transmission device 20. Subsequent to this operation, the vehicle speed is detected based on revolution speed Np of drive shaft 22 since revolution speed Nm will no longer match the vehicle speed.

Following step S4, a deceleration command is output to brake 88 at step S5. The deceleration command is applied from hybrid control circuit 52 to brake oil pressure control unit 86 via brake control unit 56. Brake oil pressure control unit 86 increases the oil pressure to actuate brake 88.

Hybrid control unit 52 realizes the drive torque corresponding to accelerator pedal position Acc detected by accelerator position sensor 82 obtained at step S1 by means of brake 88.

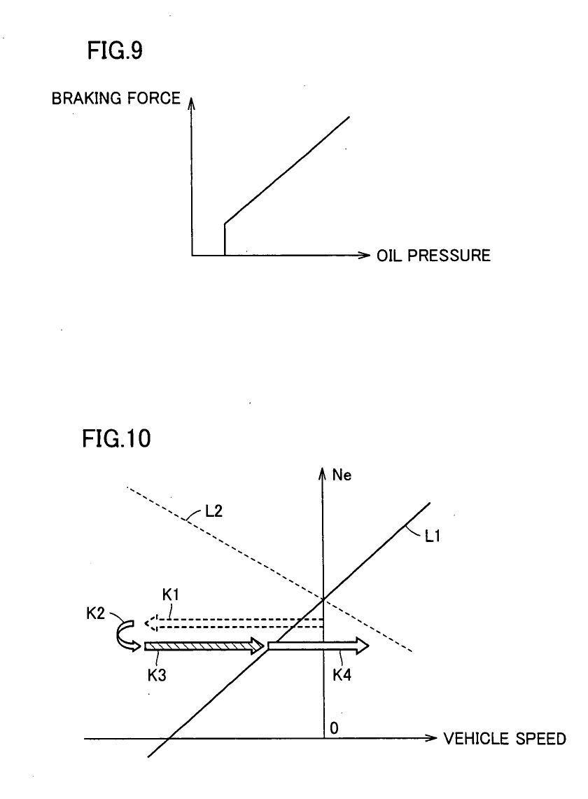

FIG. 9 represents the relationship between the brake oil pressure and braking force.

As shown in FIG. 9, the braking force is increased in proportion to the brake oil pressure. The braking force can be converted into drive torque of the negative direction. Specifically, the frictional force generated at the brake disk by the oil pressure multiplied by the radius of the brake disk corresponds to the drive torque in the negative direction.

Therefore, at step S5 of FIG. 5, brake 88 will be actuated when the accelerator pedal is stepped on even if the driver is not stepping on the brake pedal. When step S5 ends, control returns to step S3 to identify again whether first electric motor MG1 corresponds to an over-revving state. By repeating steps S3-S5, clutches C1 and C2 are disconnected such that the vehicle speed approaches zero by brake 88 until the operating point returns to region A1 of FIG. 8.

When the vehicle speed is reduced to a level where over-revving of first electric motor MG1 will not occur at step S3, control proceeds to step S6. At step S6, clutch C1 or C2 is connected to establish a state of transmitting the mechanical power from drive device 1 to transmission device 20.

At step S7, control device 50 outputs to drive shaft 22 the drive torque corresponding to the depression of the accelerator pedal by means of engine 8 and electric motors MG1 and MG2. Thus, the process ends at step S8.

In recapitulation, the present invention according to an aspect of the present invention is directed to a control method of a vehicle including a drive device applying a driving force to a wheel and a brake device applying a brake braking force to a wheel, including the step of determining whether the condition of a traveling direction and an acting direction of the driving force being opposite, and the drive device entering an operation disallowed region in response to a driving force corresponding to a driving force demand being generated at the drive device is satisfied or not (S2, S3); causing the drive device to generate a driving force corresponding to the driving force demand when the condition is not satisfied (S7), and causing the brake device to operate according to the driving force demand when the condition is satisfied (S5).

Preferably, control device 11 includes engine 8, first and second electric motors MG1 and MG2, and power split mechanism 16 having three input shafts connected to respective output shafts of first electric motor MG1, second electric motor MG2, and engine 8. The brake device includes a brake 88 exerting a frictional force on the element attached to the rotational shaft of wheel 38.

More preferably, the vehicle further includes a transmission device 20 arranged between the output shaft of the second electric motor and the drive shaft to drive the wheel. Transmission device 20 includes a clutch mechanism (C1, C2) to switch between transmission and non-transmission of the driving force. The control method for a vehicle further includes the step of controlling the clutch mechanism to attain a driving force non-transmission state when the condition is satisfied (S4).

Preferably, the vehicle further includes an accelerator pedal. The driving force demand is increased according to the step-on amount of the accelerator pedal.

FIG. 10 is a diagram to describe an example of the behavior of the vehicle of the present embodiment.

FIG. 10 shows a MG1 over-revving line L2 when the shift range is at the “R” range, in addition to MG1 over-revving line L1 when the shift range is at the “D” range already shown in FIG. 8.

When shift lever 48 is at the “D” or “M” position, the region above over-revving line L1 is the operation disallowed region. When shift lever 48 is at the “R” position, the region above over-revving line L2 is the operation disallowed region.

Arrow K1 indicates that the vehicle is moving backwards with the shift range set at “R”, and the vehicle speed is increased in the negative direction. Arrow K2 indicates that the range is switched to “D” in response to the driver moving the shift lever to the “D” position from the “R” position. By this range switching, the over-revving line is switched from L2 to L1. Therefore, the operating point will be located in the operation disallowed region. Accordingly, clutches C1 and C2 of FIG. 2 are both set to a released state. Revolution speed Nm of transmission member 18 is controlled to the revolution speed belonging to the operation allowed region.

When the driver steps on the accelerator pedal to demand moving in the forward direction at this stage, control device 50 operates the brake instead of causing engine 8 and/or electric motors MG1 and MG2 to generate forward torque. Accordingly, the vehicle speed (revolution speed Np of drive shaft 22) approaches zero, as shown by arrow K3.

When the vehicle speed approaches zero such that the operating point is located below over-revving line L1, clutch C1 or C2 is connected, and drive transmission mechanism 10 is restored to a state that allows transmission of the torque generated at drive device 11 to transmission device 20.

If the accelerator pedal is still depressed, the general forward control based on the engine and electric motor is executed, so that the vehicle speed is increased in the positive direction, as indicated by arrow K4.

Although the embodiment was described based on FIG. 1 in which control device 50 effects control by sharing various information through the communication among engine control unit 58, hybrid control unit 52, stepped transmission control unit 54, and brake control unit 56, the present invention is not limited thereto. Control device 50 may be implemented by one computer, or further divided into a plurality of control units to be realized by a plurality of computers.

According to the present embodiment, an appropriate vehicle behavior with respect to the torque demand from the driver can be realized while gaining protection of electric motor MG1, when the vehicle is moving in a direction opposite to the direction indicated by the shift range.

Although the present embodiment is based on a hybrid vehicle with an automatic transmission as an example, the present invention is not limited thereto. The present invention is applicable to a hybrid vehicle absent of an automatic transmission, an electric vehicle or fuel-cell vehicle without an engine, or an engine-mounted vehicle absent of a wheel driving motor. In the case of an electric vehicle, the motor heat generation region due to overcurrent corresponds to the operation disallowed region. In the case of a gasoline vehicle, a detected state of engine malfunction in addition to engine over-revving corresponds to the operation disallowed region.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A vehicle comprising:
a drive device applying a driving force to a wheel,
a brake device applying a braking force to said vehicle, and
a control device controlling said drive device and said brake device,
wherein, when a traveling direction and an acting direction of said driving force are opposite, said control device causes said drive device to generate a driving force corresponding to a driving force demand in an event of said drive device not entering an operation disallowed region even if said driving force corresponding to the driving force demand is generated at said drive device, and causes said brake device to operate corresponding to said driving force demand in the event of said drive device entering said operation disallowed region if said driving force corresponding to said driving force demand is generated at said drive device.

2. The vehicle according to claim 1, wherein
said drive device includes at least one of an internal combustion engine and an electric motor, and
said brake device includes a brake exerting a frictional force on an element attached to a rotational shaft of said wheel.

3. The vehicle according to claim 2, further comprising a transmission device arranged between said drive device and a drive shaft to drive said wheel, wherein
said transmission device includes a clutch mechanism to switch between transmission and non-transmission of said driving force, and
when the traveling direction and the acting direction of the driving force are opposite, said control device controls said clutch mechanism to attain a driving force non-transmission state in the event of said drive device entering said operation disallowed region if driving force corresponding to said driving force demand is generated at said drive device.

4. The vehicle according to claim 1, wherein said drive device includes
an internal combustion engine,
first and second electric motors, and
a power split mechanism having three input shafts connected to respective output shafts of said first electric motor, said second electric motor, and said internal combustion engine,
wherein said brake device includes a brake exerting a frictional force on an element attached to a rotational shaft of said wheel.

5. The vehicle according to claim 4, further comprising a transmission arranged between the output shaft of said second electric motor and a drive shaft to drive said wheel, wherein
said transmission device includes a clutch mechanism to switch between transmission and non-transmission of said driving force, and
when the traveling direction and the acting direction of the driving force are opposite, said control device controls said clutch mechanism to attain a driving force non-transmission state in the event of said drive device entering said operation disallowed region if the driving force corresponding to said driving force demand is generated at said drive device.

6. The vehicle according to claim 1, further comprising a sensor to detect a step-on amount of an accelerator pedal,
said driving force demand being increased according to a step-on amount of said accelerator pedal.

7. A control device for a vehicle including a drive device applying a driving force to a wheel, and a brake device applying a braking force to said vehicle, comprising:
a sensor sensing a traveling direction of the vehicle, and
a control unit causing, when the traveling direction and an acting direction of the driving force are opposite, said control device to generate a driving force corresponding to a driving force demand in an event of said drive device not entering an operation disallowed region even if the driving force corresponding to the driving force demand is generated at said drive device, and said brake device to operate corresponding to said driving force demand in the event of said drive device entering said operation disallowed region if the driving force corresponding to said driving force demand is generated at said drive device.

8. The control device for a vehicle according to claim 7, wherein
said drive device includes at least one of an internal combustion engine and an electric motor, and
said brake device includes a brake exerting a frictional force on an element attached to a rotational shaft of said wheel.

9. The control device for a vehicle according to claim 8, said vehicle further comprising a transmission device arranged between said drive device and a drive shaft to drive said wheel, wherein
said transmission device includes a clutch mechanism to switch between transmission and non-transmission of said driving force, and
when the traveling direction and the acting direction of the driving force are opposite, said control device controls said clutch mechanism to attain a driving force non-transmission state in the event of said drive device entering said operation disallowed region if the driving force corresponding to the driving force demand is generated at the drive device.

10. The control device for a vehicle according to claim 7, wherein said drive device includes
an internal combustion engine,
first and second electric motors, and
a power split mechanism having three input shafts connected to respective output shafts of said first electric motor, said second electric motor, and said internal combustion engine,
wherein said brake device includes a brake exerting a frictional force on an element attached to a rotational shaft of said wheel.

11. The control device for a vehicle according to claim 10, said vehicle further comprising a transmission device arranged between the output shaft of said second electric motor and a drive shaft to drive said wheel, wherein
said transmission device includes a clutch mechanism to switch between transmission and non-transmission of said driving force, and
when the traveling direction and the acting direction of the driving force are opposite, said control device controls said clutch mechanism to attain a driving force non-transmission state in the event of said drive device entering said operation disallowed region if the driving force corresponding to said driving force demand is generated at said drive device.

12. The control device for a vehicle according to claim 7, said vehicle further comprising a sensor to detect a step-on amount of an accelerator pedal,
said driving force demand being increased according to a step-on amount of said accelerator pedal.

13. A control method for a vehicle including a drive device applying a driving force to a vehicle, and a brake device applying a braking force to said vehicle, comprising the steps of:
determining whether a condition of a traveling direction and an acting direction of the driving force being opposite and said drive device entering an operation disallowed region if a driving force corresponding to a driving force demand is generated at said drive device is satisfied or not,
generating the driving force corresponding to said driving force demand at said drive device when said condition is not satisfied, and
operating said brake device according to said driving force demand when said condition is satisfied.

14. The control method for a vehicle according to claim 13, wherein
said drive device includes at least one of an internal combustion engine and an electric motor, and
said brake device includes a brake exerting a frictional force on an element attached to a rotational shaft of said wheel.

15. The control method for a vehicle according to claim 14, said vehicle further comprising a transmission device arranged between said drive device and a drive shaft to drive said wheel,
wherein said transmission device includes a clutch mechanism to switch between transmission and non-transmission of said driving force, and
said control method further comprising the step of controlling said clutch mechanism to attain a driving force non-transmission state when said condition is satisfied.

16. The control method for a vehicle according to claim 13, wherein said drive device includes
an internal combustion engine,
first and second electric motors, and
a power split mechanism having three input shafts connected to respective output shafts of said first electric motor, said second electric motor, and said internal combustion engine,
wherein said brake device includes a brake exerting a frictional force on an element attached to the rotational shaft of said wheel.

17. The control method for a vehicle according to claim 16, said vehicle further comprising a transmission arranged between the output shaft of said second electric motor and a drive shaft to drive said wheel,
wherein said transmission device includes a clutch mechanism to switch between transmission and non-transmission of said driving force, and
said control method further comprising the step of controlling said clutch mechanism to attain a driving force non-transmission state when said condition is satisfied.

18. The control method for a vehicle according to claim 13, said vehicle further comprising a sensor to detect a step-on amount of an accelerator pedal,
said driving force demand being increased according to a step-on amount of said accelerator pedal
